(19) United States
(12) Patent Application Publication
(10) Pub. No.: US 2007/0046012 A1
(43) Pub. Date: Mar. 1, 2007

(54) Highway nose for fuel economy invention

(76) Inventor: Joseph Morgese, Daytona Beach, FL (US)

Correspondence Address: JOSEPH MORGESE, Suite 606, PMB 389, 1500 Beville Road, Daytona Beach, FL, 32114, US

(21) Appl. No.: 11/511,739

(22) Filed: Aug. 28, 2006

Related U.S. Application Data
(60) Provisional application No. 60/712,081, filed on Aug. 29, 2005.

(51) Int. Cl. B60K 28/00; B60J 11/00

(52) U.S. Cl. 280/770; 180/271

(57) ABSTRACT

The Highway Nose For Fuel Economy increases a vehicles aerodynamics during highway speeds. The arrow, cone or nose shape that it forms at the front of the vehicle expands outward where space is not an issue and yet will contract back in against the vehicle when maneuverability is needed, as in city driving and when parked. Using any variety of materials, preferably lightweight and firm enough to withstand the wind velocity of highway speeds and using a means (7) for protracting the device belonging to a group comprising compressed air, hydraulics, electrical or even just manually. As well, it can be an airbag, which fills up with compressed air and forms a sort of airplane nose shape or it could be like a modified umbrella-like contraption. So, as soon as the driver gets on the highway, he flips a switch, and out it comes and then, when he gets off the highway, he flips the switch and it retracts back up against the bumper.

### CROSS-REFERENCE TO RELATED APPLICATIONS

This application claims the benefit of Provisional Patent Application Ser. No. 60/712,081, filed on Aug. 29, 2005

### BACKGROUND OF INVENTION

1. Field of Invention

This invention caters to transportation, and the need to enhance aerodynamics on the highway. Specifically, a device which can be found on a car, pick up or commercial vehicle, and remains snug up against the bumper when the vehicle is parked or in the city traffic, but will, whenever needed, upon entering a highway, extend outward and forward and form a pointed shape in the front of the vehicle, thereby enhancing aerodynamics, for some fuel savings for the vehicle's owner and the nation as a whole and in such a way as to not adversely interrupt necessary cooling air flow to the radiator.

2. Discussion of Prior Art

Aerodynamic designs for fuel economy have always been used by vehicle designers by incorporating into the design of the actual vehicle but this invention seeks to take even further advantage of aerodynamic principles out on the highway, where space would not be an issue, and yet, where aerodynamic improvement would reap the most benefit. This invention does not rely on actual vehicle design, but is added onto an existing design. Esthetic design would be possible, even going so far as to incorporate this invention into the design of future bumpers, so that one would not even notice it when it's not being used.

### OBJECTS AND ADVANTAGES

Accordingly, several objects and advantages of the Highway Nose For Fuel Economy are:
(a) to provide improved aerodynamics to any vehicle traveling at highway speeds, and where space would not be an issue, and yet retract back up against the vehicle in city traffic or when parked, where space would be needed.
(b) A simple flip of a switch would trigger the opening of it by means of pneumatics, hydraulics, electric motor, or even just manually, to protract and contract a device forward of the vehicle
(c) can be lightweight yet sturdy enough to withstand highway wind velocity
(d) another embodiment can be like an airbag
(e) yet another embodiment can be an umbrella-like structure
(f) all of them would provide an additional safety barrier, especially the airbag.
(g) And all of them designed so that none of them would adversely affect necessary cooling airflow to the radiator.

Further objects and advantages of my invention will become apparent from a consideration of the drawings and ensuing description.

### DESCRIPTION OF DRAWINGS

FIG. 1 is a top view, wire frame version of a protracted and in use version of the ‘Highway Nose’.

FIG. 2 is an isometric, rendering version of a protracted and in use version of the ‘Highway Nose’.

FIG. 3 is an isometric, rendering version of a contracted version of the ‘Highway Nose’.

FIG. 4 is an isometric, rendering version of a protracted air bag style ‘Highway Nose’.

FIG. 5 is an isometric, rendering version of a contracted air bag style ‘Highway Nose’.

FIG. 6 is a top view sketch of a protracted air bag style ‘Highway Nose’

### LIST OF REFERENCE NUMERALS

1—front of vehicle
2—air space between front of vehicle and connecting plate
3—air baffles
4—side flanges of highway nose
5—front part of highway nose
6—connecting plate of highway nose assembly against the bumper of front of vehicle
7—protracting devices for each side flange and the front section of the highway nose
8—air bag
9—air bag housing
10—vacuum air pump
11—brackets

### SUMMARY OF INVENTION

The ‘Highway Nose’ is installed at the front of the vehicle and opens up to form the shape of a nose once the vehicle is on the highway, thereby increasing aerodynamics for the vehicle where space would not be an issue, and yet, whenever in city traffic or parked, it would tuck away up against the vehicle, taking relatively less space.

It would be designed as to not adversely affect necessary cooling air flow to the radiator and can be made of any variety of materials, lightweight and firm enough to withstand the wind velocity of highway speeds. So, as soon as the driver gets on the highway, he flips a switch, and out it comes and then, when he gets off the highway, he flips the switch and it retracts back up against the bumper at the front of the vehicle.

### DESCRIPTION OF INVENTION

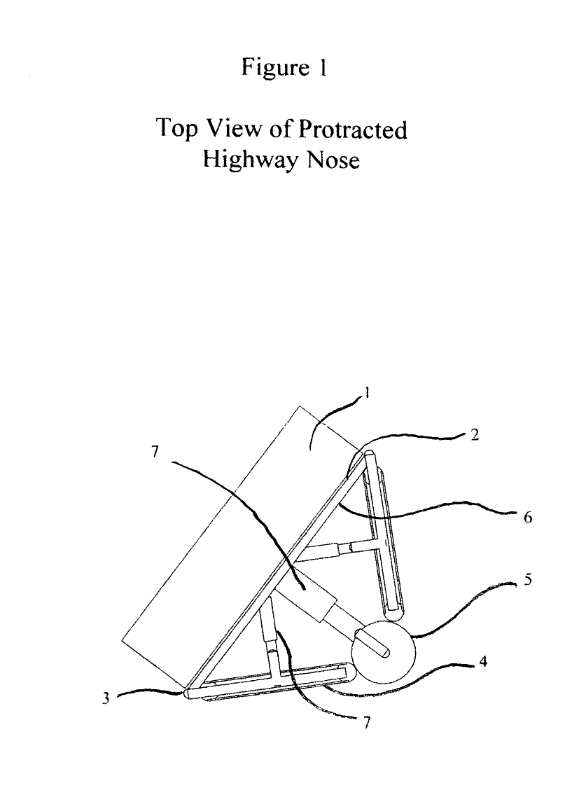

FIG. 1 shows a top view of a protracted version of ‘The Highway Nose For Fuel Economy’. The Highway Nose is attached to the front of the vehicle, 1, with a connecting plate, 5, spaced forward with enough air space, 2, whereby, with the help of air baffles, 3, allowing some of that deflected air from the Highway Nose to flow in behind it towards the radiator. The Highway Nose consists of two side flanges, 4, and a front part, 5, which form the arrow shape for air deflection, and these are protracted as illustrated here, or contracted by the devices shown, 7, which can be pneumatic, hydraulic, or electric systems. One of a series of brackets, 11, is shown as well.

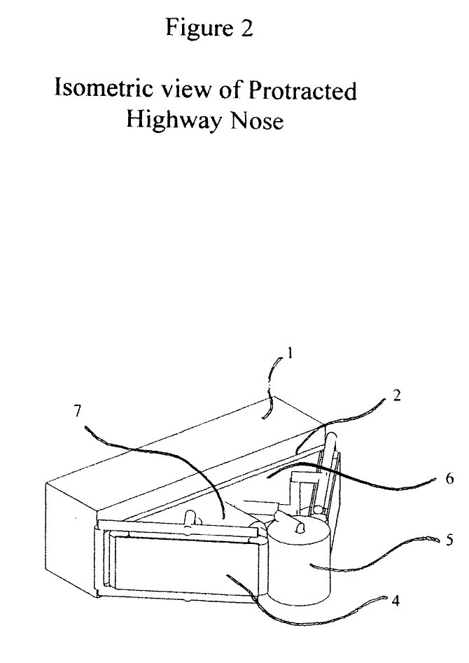

FIG. 2 shows an isometric perspective rendering of the drawing of FIG. 1, looking at it from the front.

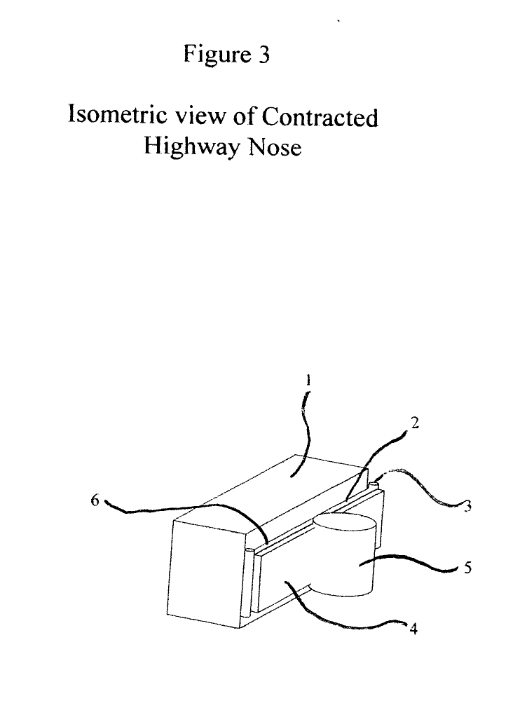

FIG. 3 shows a contracted version of the Highway Nose as it would appear when the vehicle is in city traffic or parked.

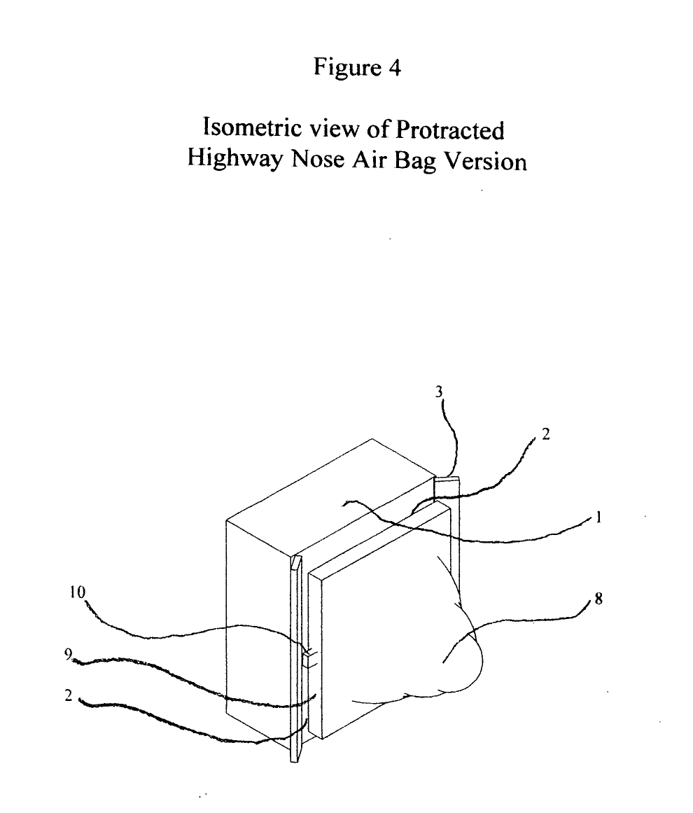

FIG. 4 shows an isometric perspective rendering of an air bag style Highway Nose as protracted. The air bag, 8, is protracted outward from it's housing, 9, and the vacuum air pump, 10, is shown here as well that will draw the air out from it when it is no longer needed.

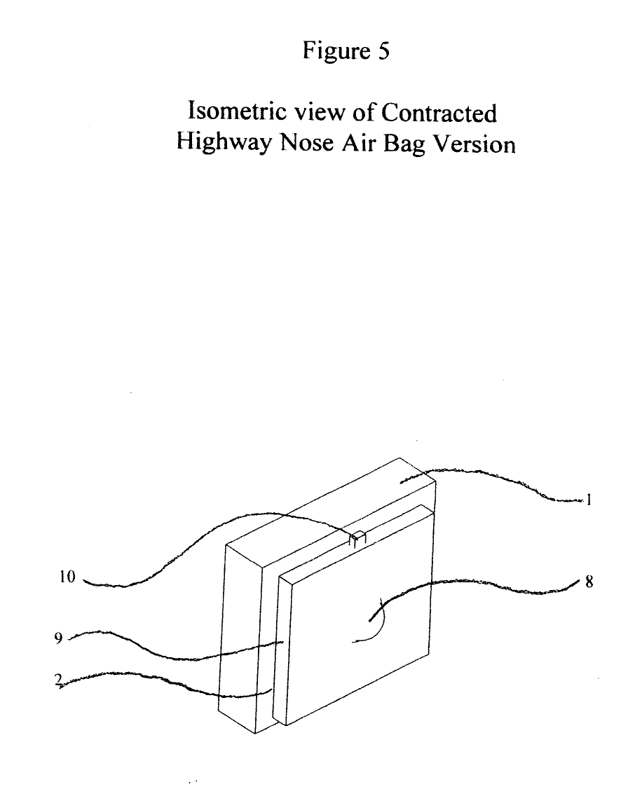

FIG. 5 shows an isometric perspective rendering of the same air bag as it would appear contracted.

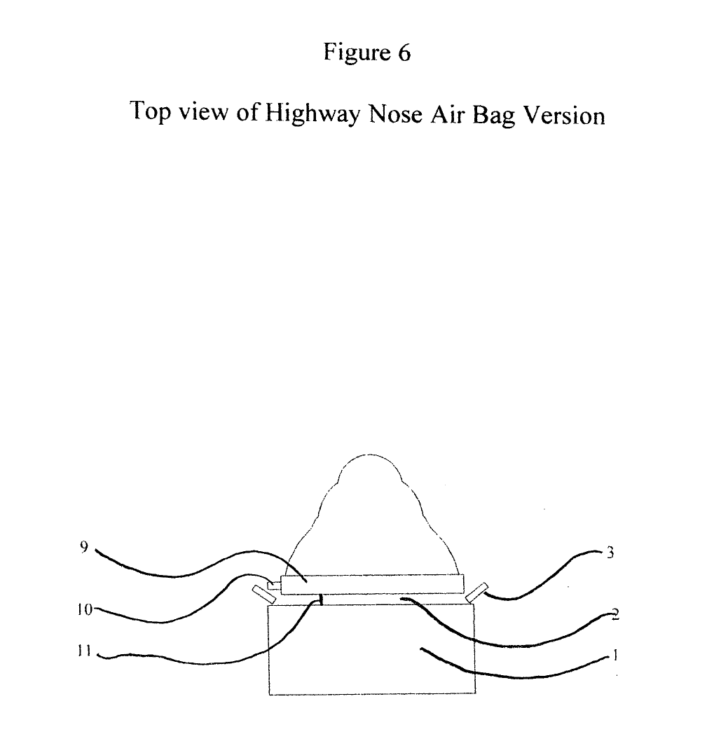

FIG. 6 shows the top view sketch of the air bag style Highway Nose showing the air space, 2, and the air baffles, 3 and one of a series of brackets, 11, that fasten the Highway Nose to the vehicle.

### OPERATION OF INVENTION

The Highway Nose is normally in the contracted position as shown in FIGS. 3 and 5 (air bag version). A switch located at the driver's seat activates the Highway Nose to open out when the vehicle enters a highway. The devices, 7, of FIG. 1 expand out and cause the side flanges, 4, and the front part, 5, to form an arrow shape. The devices, 7, can be either, pneumatic, hydraulic or electric.

In the air bag version, compressed air would fill the air bag thus overcoming the contractive devices, whether it be springs or elastics, to fill out the air bag and thus form a nose or cone shape at the front of the vehicle. When no longer needed, the compressed air would be allowed to escape and the springs or elastics would resume their former natural state. There may be a vacuum air pump, 10, to assist in vacating the air bag.

Brackets, 11, hold the entire Highway Nose contraption out away from the front of the vehicle, 1, creating an air space, 2, and baffles, 3, help to feed some of the air diverted by the Highway Nose back to the radiator.

### CONCLUSIONS, RAMIFICATIONS AND SCOPE OF INVENTION

Thus the reader will see that the Highway Nose For Fuel Economy provides enhanced aerodynamics to the vehicle, on the highway, where space is not an issue, and where the high speeds would benefit from it. And yet, when in the city traffic or when parked, it would be contracted against the vehicle, giving the driver more maneuverability, as is needed at this time. As well as the added safety barrier that this invention affords the vehicle, especially the air bag version.

While my above description contains many specificities, these should not be construed as limitations on the scope of the invention, but rather, as exemplifications of preferred embodiments thereof. Many other variations are possible. For example, an umbrella-like structure.

Accordingly, the scope of the invention should be determined not by the embodiments illustrated, but by the appended claims and their legal equivalents.

1- A method for improving aerodynamics on a vehicle driving at highway speeds, comprising the steps of:
(a) the driver flips a switch which activates a protracting device, and
(b) the front of the vehicle re-configures to form a pointed nose, whereby the airflow will be directed around the vehicle.

2- The method of claim 1, whereby said protracting device uses a means selected from a group consisting of pneumatics, hydraulics, electric motor that would propel the device forward into the desired shape

3- The method of claim 1, whereby materials used for said device may be lightweight, yet sturdy enough to withstand highway speed velocities

4- The method of claim 1, whereby said device may contract back against said vehicle whenever said vehicle is off the highway and where the additional space is desired as when said vehicle is in the city traffic or parked

5- The method of claim 1, whereby an additional way of achieving the desired aerodynamics for said vehicle would be an inflatable air bag which forms the shape of a nose

6- The method of claim 1, whereby said airbag would also provide additional safety buffering in the event of a collision

7- The method of claim 1, whereby said airbag would employ a means, selected from a group consisting of springs, elastics and vacuum suction devices, for retracting itself back into it's housing, back up against the front of said vehicle, automatically when the highway nose is no longer needed.

8- The method of claim 1, whereby the brackets attaching the entire contraption to the front of said vehicle allow for an air space and air baffles are used to help increase air flow to the radiator

9- A machine for improving aerodynamics on a vehicle driving at highway speeds, comprising of:
a. a connecting plate that attaches to the front of a vehicle
b. side flanges
c. a front part that forms the nose of the device
d. protracting devices for each of the side flanges and the front part that allow for movement of said side flanges and front part forward from said vehicle whereby the front part of said vehicle re-configures to form a pointed nose whereby the airflow will be directed around the vehicle.
e. brackets attaching said connecting plate to said front of vehicle allowing for an air space between the two
f. air baffles to help bring some of the diverted air to the radiator
g. in the case of said airbag method, the above parts b, c, and d would be eliminated and the connecting plate would also serve as the airbag housing

10- The machine of claim 9, whereby said protracting device uses a means selected from a group consisting of pneumatics, hydraulics, electric motor that would propel the device forward into the desired shape

11- The machine of claim 9, whereby materials used for said device and said side flanges and said front part may be lightweight

12- The machine of claim 9, whereby materials used for said device and said side flanges and said front part may be sturdy enough to withstand highway speed velocities

13- The machine of claim 9, whereby said device may contract back against said vehicle whenever said vehicle is off the highway and where the additional space is desired as when said vehicle is in the city traffic or parked

14- The machine of claim 9, whereby an additional way of achieving the desired aerodynamics for said vehicle would be an inflatable air bag which forms the shape of a nose

15- The machine of claim 9, whereby said airbag would also provide additional safety buffering in the event of a collision

16- The machine of claim 9, whereby said airbag would employ a means, selected from a group consisting of springs, elastics and vacuum suction devices, for retracting itself back into it's housing, back up against the front of said vehicle, automatically when the highway nose is no longer needed.

17- The machine of claim 9, whereby the fastening brackets at the front of said vehicle allow for an air space and air baffles help divert air to the radiator
